(19) United States
(12) Patent Application Publication
(10) Pub. No.: US 2020/0039435 A1
(43) Pub. Date: Feb. 6, 2020

(54) ONBOARD CAMERA SYSTEM FOR ELIMINATING A-PILLAR BLIND AREAS OF A MOBILE VEHICLE AND IMAGE PROCESSING METHOD THEREOF

(71) Applicant: Chunghwa Picture Tubes, LTD., Taoyuan City (TW)

(72) Inventors: Li-Chuan Chang, Taoyuan City (TW); Chung-Lin Chia, Taoyuan City (TW)

(73) Assignee: Chunghwa Picture Tubes, LTD., Taoyuan City (TW)

(21) Appl. No.: 16/159,722

(22) Filed: Oct. 15, 2018

(30) Foreign Application Priority Data
Aug. 2, 2018 (CN) 201810869285.0

(51) Int. Cl. B60R 1/00; G06T 7/536

(52) U.S. Cl. CPC B60R 1/00; G06T 7/536; G06T 2207/30252; B60R 2300/8026; B60R 2300/30; B60R 2300/202

(57) ABSTRACT

An onboard camera system for eliminating A-pillar blind areas of a mobile vehicle and an image processing method thereof are provided. The onboard camera system arranged on the mobile vehicle includes an image capturing device, a processor, and a display device. The image capturing device captures blind area images obscured by the A-pillars. The blind area images captured at a first time point and a second time point are called a first image and a second image, and a photoshooting angle of the image capturing device stays unchanged at the first and second time points. The processor receives the first and second images from the image capturing device. The processor obtains an image depth of an object based on the first and second images to further generate a third image. The display device displays the third image to enable a driver to see the scene obscured by the A-pillars.

### CROSS-REFERENCE TO RELATED APPLICATION

This application claims the priority benefit of China application serial no. 201810869285.0, filed on Aug. 2, 2018. The entirety of the above-mentioned patent application is hereby incorporated by reference herein and made a part of this specification.

### BACKGROUND

### Technical Field

The disclosure relates to an onboard camera system, and more particularly to an onboard camera system for eliminating A-pillar blind areas of a mobile vehicle and an image processing method thereof.

### Description of Related Art

Various mobile vehicles, e.g., cars, driven by drivers are currently very popular modes of transportation in daily life. However, when driving a car, the sight of the driver is easily blocked by standing pillars (also known as A-pillars) on both sides of the front windshield to create so-called A-pillar blind areas, which may mislead the driver judge and cause traffic accidents.

Although narrowing or hollowing out the A-pillars may help improve the driver's field of vision, the A-pillars are responsible for supporting the front weight of the car and should have a certain amount of strength, which poses limitations to the improvement made by narrowing or hollowing out the A-pillars. According to some related art, a reflective mirror is capable of better eliminating the driver's blind areas; however, during driving, the most intuitive and quick way for the driver to obtain the information is through the eyes to respond to the external environment. The reflected image does not correctly correspond with the sight of the driver nor the distance to the external object, thus increasing the response time of the driver and enhancing the risk.

Therefore, there is a need for an auxiliary automotive vision system that does not degrade the structural safety performance of the vehicle and can accurately correspond with the sight angle of the driver, so as to improve safety and comfort of driving.

### SUMMARY

In view of the above, the disclosure provides an onboard camera system for eliminating A-pillar blind areas of a mobile vehicle and an image processing method thereof, which can improve safety and comfort of driving.

According to an embodiment of the invention, an onboard camera system that eliminates A-pillar blind areas of a mobile vehicle is arranged on the mobile vehicle. The onboard camera system includes an image capturing device, a processor and a display device. The image capturing device is arranged on the mobile vehicle for capturing a plurality of blind area images obscured by A-pillars of the mobile vehicle. The blind area images that are captured at the first time point and the second time point are respectively referred to as a first image and a second image, and a photoshooting angle of the image capturing device stays unchanged at the first time point and the second time point. The processor is coupled to the image capturing device and receives the first image and the second image. The processor obtains an image depth of an object according to the first image and the second image to further generate a third image. The display device is coupled to the processor for displaying the third image to enable a driver to see a scene obscured by the A-pillars.

In an embodiment of the invention, the processor in the onboard camera system compares the first image and the second image to determine relative shift information of the object in the first image and the second image, and obtains the image depth according to the relative shift information. The processor generates the third image based on at least one of the first image and the second image and the image depth.

In an embodiment of the invention, the onboard camera system further includes a storage device. The storage device is coupled to the processor for storing an image depth lookup table. Here, the image depth lookup table records a plurality of reference shift information and a plurality of reference image depths corresponding to the reference shift information. Here, the processor searches for the image depth from the image depth lookup table according to the relative shift information.

In an embodiment of the invention, the image depth lookup table in the onboard camera system also records a plurality of perspective transformation parameters corresponding to the reference shift information. The processor performs a perspective transformation process on the third image according to the corresponding perspective transformation parameter to generate the third image based on a direction of a sight of the driver.

In an embodiment of the invention, the processor in the onboard camera system extracts the first image from an image captured at the first time point according to a range obscured by the A-pillars, and extracts the second image from an image captured at the second time point.

In an embodiment of the invention, the number of image frames of the image capturing device in the onboard camera system is greater than or equal to 120 frames/second.

According to an embodiment of the invention, an image processing method for eliminating A-pillar blind areas of a mobile vehicle is applicable to an onboard camera system arranged on the mobile vehicle, and the method includes: capturing a plurality of blind area images obscured by A-pillars of the mobile vehicle by an image capturing device, the blind area images captured at a first time point and a second time point being respectively referred to as a first image and a second image, a photoshooting angle of the image capturing device staying unchanged at the first time point and the second time point; obtaining an image depth of an object according to the first image and the second image to further generate a third image; and displaying the third image to enable a driver to see a scene obscured by the A-pillars.

In an embodiment of the invention, the step of generating the third image in the image processing method includes: comparing the first image with the second image to determine relative shift information of the object in the first image and the second image, and obtaining the image depth according to the relative shift information; generating the third image based on at least one of the first image and the second image and image depth.

In an embodiment of the invention, the step of the generating the third image in the image processing method includes: obtaining the image depth and a corresponding perspective transformation parameters from an image depth lookup table according to the relative shift information, wherein the image depth lookup table records a plurality of reference shift information and a plurality of reference image depths corresponding to the reference shift information and a plurality of the perspective transformation parameters; performing a perspective transformation process on the third image according to the corresponding perspective transformation parameter to generate the third image based on a direction of a sight of the driver.

In an embodiment of the invention, a time difference between the first time point and the second time point is less than or equal to 1/120 second.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a functional block diagram illustrating an onboard camera system for eliminating A-pillar blind areas of a mobile vehicle according to an embodiment of the invention.

FIG. 2A is a schematic diagram of an onboard camera system and a mobile vehicle according to an embodiment of the invention.

FIG. 2B is a schematic view of a sight of a driver looking from the inside of the mobile vehicle to the outside according to an embodiment of the invention.

FIG. 3 is a flowchart of an image processing method for eliminating A-pillar blind areas of a mobile vehicle according to an embodiment of the invention.

FIG. 4A is a schematic diagram of a first image according to an embodiment of the invention.

FIG. 4B is a schematic diagram of a second image according to an embodiment of the invention.

FIG. 5 is a schematic illustration of an image depth lookup table according to an embodiment of the invention.

### DESCRIPTION OF THE EMBODIMENTS

Reference will now be made in detail to the exemplary embodiments. Whenever possible, the same reference numbers are used in the drawings and description to refer to the same or similar port.

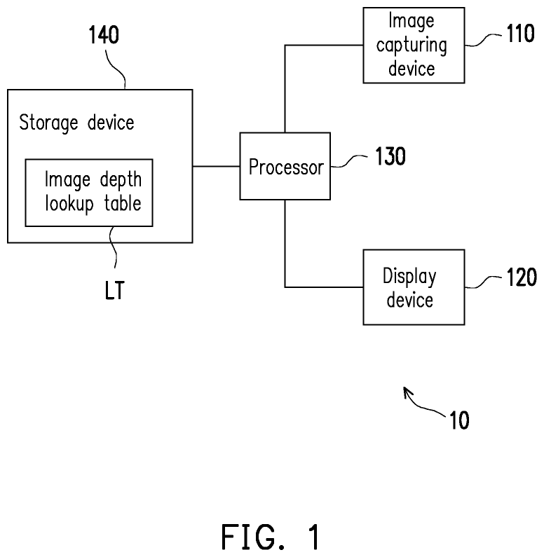

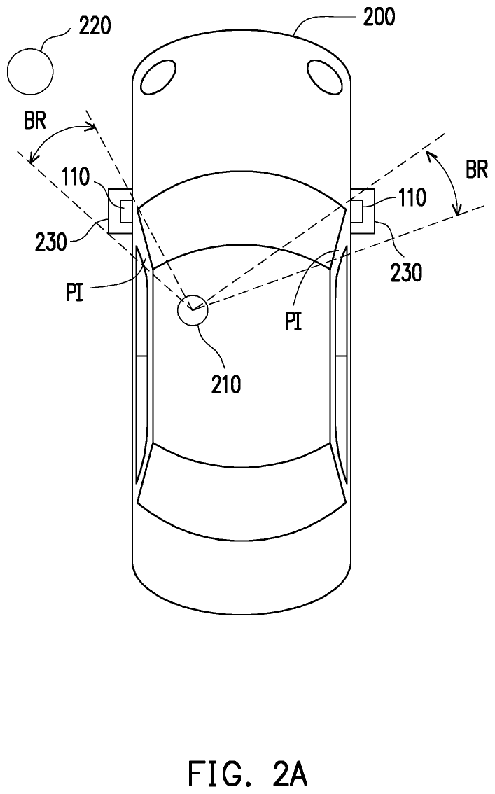

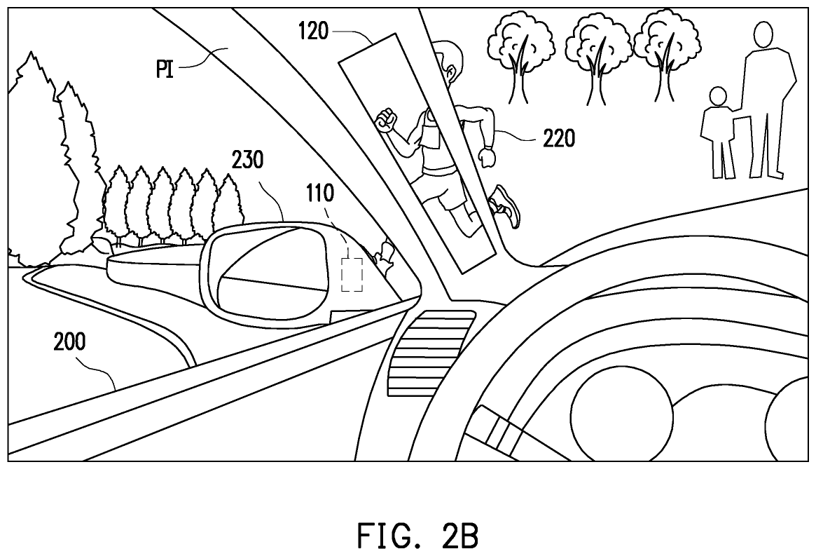

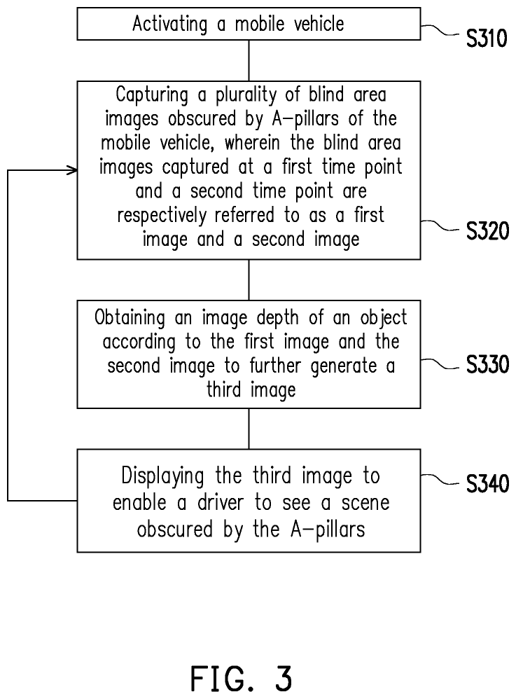

FIG. 1 is a functional block diagram illustrating an onboard camera system for eliminating A-pillar blind areas of a mobile vehicle according to an embodiment of the invention. FIG. 2A is a schematic diagram of an onboard camera system and a mobile vehicle according to an embodiment of the invention. FIG. 2B is a schematic view of a sight of a driver looking from the inside of the mobile vehicle to the outside according to an embodiment of the invention. FIG. 3 is a flowchart of an image processing method for eliminating A-pillar blind areas of a mobile vehicle according to an embodiment of the invention.

With reference to FIG. 1 to FIG. 2B, an onboard camera system 10 may be arranged on various mobile vehicles. The mobile vehicle is one kind of transportation that is moved through the control of human beings, such as various types of automobiles, buses, boats, airplanes, and mobile machinery, which should not be construed as a limitation in the disclosure. In the embodiments depicted in FIG. 1 to FIG. 2B, the mobile vehicle 200 is a car that is operated by a driver 210. If there is no onboard camera system 10, the sight of the driver 210 is blocked by A-pillars PI of the mobile vehicle 200, so that A-pillar blind areas BR are generated. As such, the driver 210 is unable to see the complete object (e.g., a pedestrian 220) outside the mobile vehicle 200.

The onboard camera system 10 is configured to eliminate the A-pillar blind areas BR of the mobile vehicle 200. The onboard camera system 10 may be positioned anywhere in the mobile vehicle 200 and therefore is not directly shown in FIG. 2A and FIG. 2B.

The onboard camera system 10 includes an image capturing device 110, a display device 120, a processor 130, and a storage device 140. The image capturing device 110 is arranged on the mobile vehicle 200 for capturing a plurality of blind area images obscured by the A-pillars PI of the mobile vehicle 200. The blind area images that are captured at a first time point and a second time point are referred to as a first image and a second image, respectively. A photoshooting angle of the image capturing device 110 stays unchanged at the second time point and the first time point. The processor 130 is coupled to the image capturing device 110, the display device 120, and the storage device 140. The processor 130 obtains an image depth of an object according to the first image and the second image to further generate a third image. The display device 120 receives the third image from the processor 130 to display the third image to enable the driver 210 to see a scene obscured by the A-pillars PI.

Specifically, the image capturing device 110 is, for instance, a charge-coupled device (CCD), a complementary metal-oxide semiconductor (CMOS) photosensitive device, and so forth. The image capturing device 110 may be arranged on a rearview mirror 230 of the mobile vehicle 200 or on the outer side of the A-pillars PI, and the disclosure does not limit the location where the image capturing device 110 is arranged.

The display device 120 is, for instance, a liquid crystal display (LCD), an organic light emitting diode (OLED), or the like.

The processor 130 is, for example, a central processing unit (CPU), a programmable general-purpose or special-purpose microprocessor, a digital signal processor (DSP), a programmable controller, an application specific integrated circuits (ASIC), a programmable logic device (PLD), or any other similar device or a combination of these devices.

The storage device 140 is, for instance, any form of fixed or movable random access memory (RAM), read-only memory (ROM), flash memory, similar device, or a combination thereof. The storage device 140 may record the software required for the execution of the processor 130 or images captured by the image capturing device 110.

Specifically, with reference to FIG. 1 to FIG. 2B and FIG. 3, the image processing method depicted in FIG. 3 is adapted to the onboard camera system 10, and the onboard camera system 10 provided in the present embodiment and the image processing method thereof will be explained with reference to various devices in the onboard camera system 10.

First, in step S310, the mobile vehicle 200 is activated. The onboard camera system 10 is activated after the mobile vehicle 200 starts moving. In another embodiment, the onboard camera system 10 may be activated together with the mobile vehicle 200 or manually activated by the driver 210, which should not be construed as a limitation in the disclosure.

In step S320, the image capturing device 110 may continue to photoshoot the scene outside the mobile vehicle 200. Particularly, the image capturing device 110 may continuously record the video of the blind area images outside the mobile vehicle 200, or capture a plurality of blind area images at different time points. For instance, the blind area images captured at the first time point are referred to as first images, and the blind area images captured at the second time point are called second images. In an embodiment, the position of the lens of the image capturing device 110 is fixed relative to the A-pillars PI during capturing, i.e., the photoshooting angle at which the first image is captured is the same as the photoshooting angle at which the second image is captured.

In an embodiment, the image capturing device 110 is, for instance, a video recorder. The first image and the second image are two consecutive frames, and the time difference between the first time point and the second time point is a frame interval. Since the mobile vehicle 200 may move at a high speed, the number of image frames of the image capturing device 110 may be greater than or equal to 120 frames/second; that is, the time difference between the first time point and the second time point is less than or equal to 1/120 second.

In step S330, the processor 130 is coupled to the image capturing device 110 and receives a plurality of blind area images including the first image and the second image. The processor 130 obtains the image depth of the object according to the first image and the second image to further generate the third image. How to generate the third image is elaborated hereinafter.

In order to reduce the computational burden, the processor 130 may, according to the range obscured by the A-pillars PI, extract the first image from an image captured at the first time point and extract the second image from an image captured at the second time point. In this way, the size of the to-be-calculated image may be reduced because only the range obscured by the A-pillars PI is processed, thereby reducing the computational burden.

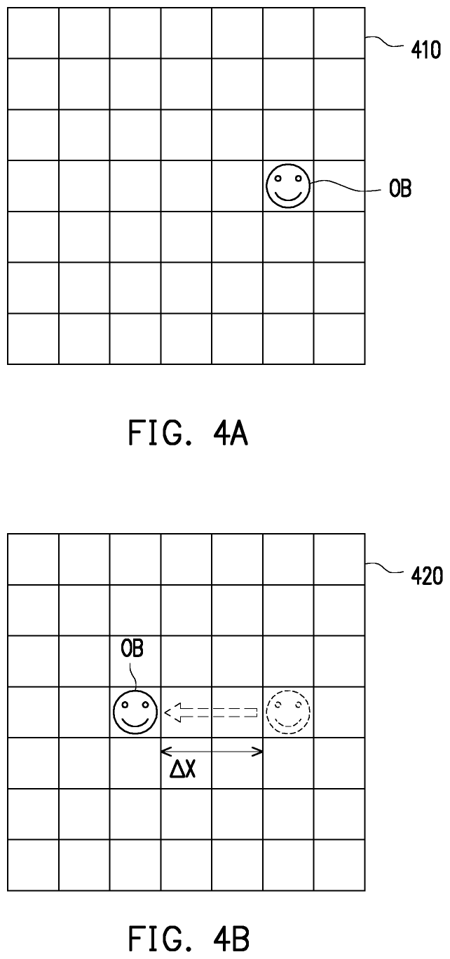

FIG. 4A is a schematic diagram of a first image according to an embodiment of the invention. FIG. 4B is a schematic diagram of a second image according to an embodiment of the invention. With reference to FIG. 4A and FIG. 4B, the first image 410 includes an object OB, and the object OB is, for instance, the pedestrian 220 depicted in FIG. 2B. In the second image 420, the position of the object OB changes. The processor 130 may identify the object OB in the first image 410 and the second image 420 and compare the first image 410 with the second image 420 to determine relative shift information of the object OB in the first image 410 and the second image 420. The relative shift information includes, for instance, pixel displacement ΔX of the object OB between the first image 410 and the second image 420.

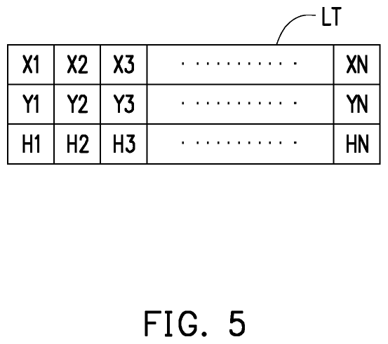

FIG. 5 is a schematic illustration of an image depth lookup table according to an embodiment of the invention. With reference to FIG. 5, the storage device 140 is configured to store an image depth lookup table LT, and the image depth lookup table LT records a plurality of reference shift information X1, X2, X3 to XN and corresponding reference image depths Y1, Y2, Y3 to YN. In the present embodiment, the image depth lookup table LT also records a plurality of perspective transformation parameters H1, H2, H3 to HN corresponding to the reference shift information X1, X2, X3 to XN.

The processor 130 may search for the image depth of the object OB from the image depth lookup table LT according to the relative shift information. In an embodiment, when the pixel displacement ΔX is equal to the reference shift information X3, the processor 130 may obtain the image depth of the object OB through searching for the corresponding reference image depth Y3 from the image depth lookup table LT or calculate the image depth of the object OB by interpolation. In another embodiment, the processor 130 may obtain the image depth of the object OB according to the speed of the mobile vehicle 200, the pixel displacement ΔX, the time difference between the first time point and the second time point, or the reference image depth Y3. Next, the processor 130 generates the third image according to at least one of the first image 410 and the second image 420 and the image depth of the object OB.

The processor 130 may perform image calibration on at least one of the first image 410 and the second image 420 according to the image depth of the object OB. Thereby, other objects in the third image are properly deformed according to the distance to the object OB, so that the driver 210 may intuitively determine whether the objects are far or close.

The processor 130 may also perform image perspective transformation on the third image. When the image capturing device 110 is arranged on the rearview mirror 230 of the mobile vehicle 200 or on the outer side of the A-pillars PI, there is an angle difference between the photoshooting direction of the image capturing device 110 and the direction of the sight of the driver 210. Hence, the issue of different view angles may arise when the driver 210 views the images captured by the image capturing device 110. In this embodiment, the processor 130 may also adjust the view angle of the third image according to the above-described angle difference. The processor 130 may search for the perspective transformation parameter of the object OB from the image depth lookup table LT according to the relative shift information, e.g., the perspective transformation parameter H3. Next, the processor 130 performs a perspective transformation process on the third image according to the perspective transformation parameter H3 to generate the third image based on the direction of the sight of the driver 210. The details of the implementation of the perspective transformation process are known to people skilled in the art from common knowledge and will not be described again.

In an embodiment, the processor 130 may also optimize the image (the first image, the second image, or the third image). For instance, the processor 130 may adjust the brightness of the image or perform a filtering process to remove image noise and improve image quality.

Thereafter, in step S340, the display device 120 receives the third image and displays the third image. The angle of the third image and the deformation of the third image have been adjusted by the processor 130, so that the image seen by the driver 210 looks like the pedestrian 220 directly observed through seeing through the A-pillars PI. After step S340, the step S320 is further performed until the mobile vehicle 200 stops moving or the onboard camera system 10 stops operating.

To sum up, in the onboard camera system and the image processing method thereof for eliminating the A-pillar blind areas of the mobile vehicle according to an embodiment of the invention, the blind area images outside the A-pillars PI of the mobile vehicle 200 are continuously captured only by at least one fixed image capturing device 100; through comparison of the object in the former and the latter blind area images, the relative shift information of the object may be found, so as to further obtain the image depth of the object. After the image depth of the object is obtained, deformation calibration and perspective transformation of the blind area images may be performed to generate the third image. The display device displays the third image for the driver to see, so that the driver may feel as if the A-pillars are transparent and may directly see the scene outside. Therefore, as provided in one or more embodiments of the invention, the onboard camera system and the image processing method thereof for eliminating the A-pillar blind areas of the mobile vehicle not only eliminate the A-pillar blind areas of the mobile vehicle but also enable the driver to directly see the blind area images, thus greatly improving the safety of driving.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An onboard camera system for eliminating A-pillar blind areas of a mobile vehicle, the onboard camera system being arranged on the mobile vehicle and comprising:
an image capturing device arranged on the mobile vehicle for capturing a plurality of blind area images obscured by A-pillars of the mobile vehicle, the plurality of blind area images captured at a first time point and a second time point being respectively referred to as a first image and a second image, a photoshooting angle of the image capturing device staying unchanged at the first time point and the second time point;
a processor coupled to the image capturing device and receiving the first image and the second image, the processor obtaining an image depth of an object according to the first image and the second image to further generate a third image; and
a display device coupled to the processor for displaying the third image to enable a driver to see a scene obscured by the A-pillars.

2. The onboard camera system according to claim 1, wherein the processor compares the first image with the second image to determine relative shift information of the object in the first image and the second image, and obtains the image depth according to the relative shift information, and
the processor generates the third image according to at least one of the first image and the second image and the image depth.

3. The onboard camera system according to claim 2, further comprising:
a storage device coupled to the processor for storing an image depth lookup table, wherein the image depth lookup table records a plurality of reference shift information and a plurality of reference image depths corresponding to the plurality of reference shift information,
wherein the processor searches for the image depth from the image depth lookup table according to the relative shift information.

4. The onboard camera system according to claim 3, wherein the image depth lookup table further records a plurality of perspective transformation parameters corresponding to the plurality of reference shift information,
wherein the processor performs a perspective transformation process on the third image according to a corresponding one of the plurality of perspective transformation parameters to generate the third image based on a direction of a sight of the driver.

5. The onboard camera system according to claim 1, wherein the processor extracts the first image from an image captured at the first time point according to a range obscured by the A-pillars, and extracts the second image from an image captured at the second time point.

6. The onboard camera system according to claim 1, wherein the number of image frames of the image capturing device is greater than or equal to 120 frames/second.

7. An image processing method for eliminating A-pillar blind areas of a mobile vehicle, the image processing method being adapted to an onboard camera system arranged on the mobile vehicle and comprising:
capturing a plurality of blind area images obscured by A-pillars of the mobile vehicle by an image capturing device, the plurality of blind area images captured at a first time point and a second time point being respectively referred to as a first image and a second image, a photoshooting angle of the image capturing device staying unchanged at the first time point and the second time point;
obtaining an image depth of an object according to the first image and the second image to further generate a third image; and
displaying the third image to enable a driver to see a scene obscured by the A-pillars.

8. The image processing method according to claim 7, wherein the step of generating the third image comprises:
comparing the first image and the second image to determine relative shift information of the object in the first image and the second image, and obtaining the image depth according to the relative shift information; and
generating the third image according to at least one of the first image and the second image and the image depth.

9. The image processing method according to claim 8, wherein the step of generating the third image comprises:
obtaining the image depth and a corresponding perspective transformation parameter from an image depth lookup table according to the relative shift information, wherein the image depth lookup table records a plurality of reference shift information and a plurality of reference image depths and a plurality of the perspective transformation parameters corresponding to the plurality of reference shift information; and
performing a perspective transformation process on the third image according to the corresponding perspective transformation parameter to generate the third image based on a direction of a sight of the driver.

10. The image processing method according to claim 7, wherein a time difference between the first time point and the second time point is less than or equal to 1/120 second.
